(19) United States
(12) Patent Application Publication
(10) Pub. No.: US 2002/0185444 A1
(43) Pub. Date: Dec. 12, 2002

(54) Method of oil spill recovery using hydrophobic sol-gels and aerogels

(75) Inventors: Paul R. Coronado, Livermore, CA (US); Lawrence W. Hrubesh, Pleasanton, CA (US); John G. Reynolds, San Ramon, CA (US)

Correspondence Address: Alan H. Thompson, Assistant Laboratory Counsel, Lawrence Livermore National Laboratory, P.O. Box 808, L-703, Livermore, CA, 94551, US

(73) Assignee: The Regents of the University of California

(21) Appl. No.: 09/960,593

(22) Filed: Sep. 21, 2001

Related U.S. Application Data
(60) Provisional application No. 60/292,194, filed on May 18, 2001.

(51) Int. Cl. B01D 15/04

(52) U.S. Cl. 210/693

(57) ABSTRACT

A device that absorbs and separates oil from oil-water mixtures. The device is formed by combining an absorbent material with a support. The absorbent material is a hydrophobic sol-gel material processed to be an aerogel, with the support being a material of any type that can give the absorbent a place to reside. The absorbent or aerogel material may be coated onto or otherwise secured to the support material. When an oil-water mixture contacts the aerogel material, preferably in granulated or powdered form, the aerogel material will preferentially absorb and retain the oil phase, rejecting the water phase of the mixture. The end result is two separated streams, an oil only stream, and a water only stream.

### RELATED APPLICATION

This application relates to U.S. Provisional Application No. 60/292,194 filed May 18, 2001 and claims priority thereof.

The United States Government has rights in this invention pursuant to Contract No. W-7405-ENG-48 between the United States Department of Energy and the University of California for the operation of Lawrence Livermore National Laboratory.

### BACKGROUND OF THE INVENTION

The present invention relates to oil/water separation, particularly to a material that absorbs oil and rejects water, and more particularly to a hydrophobic aerogel material mounted to a support, and when an oil water mixture is brought into contact therewith the oil is separated from the water by being absorbed by the aerogel materials.

Utilization of petroleum for transportation fuels has brought about the necessity for control of accidental and purposeful releases of petroleum during transportation and storage. Notable releases in recent years have been: the Persion Gulf war where 2.5 to 4 million barrels were purposely dumped into the Gulf of Suez; the Exxon Valdez where 260,000 barrels were lost in the Gulf of Alaska; and the Monongahela River where 24,000 barrels were lost due to a ruptured storage tank. The environmental significance of these and other releases dictates the need for developing a wide variety of methods of remediation, particularly when climatic and location conditions preclude some types of treatment.

Several types of methods for remediation are commonly employed, including materials that disperse, materials that absorb, booms, and skimmers. All have positive and negative characteristics, depending upon the conditions of the spill. Materials that disperse oil accelerate the natural breakdown by using surfactants and soaps to thin the oil. Materials that absorb collect the oil and separate it from the water. Booms and skimmers physically corral to oil for collection.

Materials that absorb oil are attractive for some applications because of the possibility of collecting and completely removing the oil from the spill site. They in some cases can be recycled. Some properties that are necessary for good absorbing materials are: high uptake capacity, high rate of uptake, and hydrophobicity. Several absorbing materials have been developed that exhibit these properties, such as inorganic powders of clays, lime and silica, hydrocarbon and plastic polymers, cellulose based materials, and elastromers. These materials all show porosity and the ability to absorb oil in the presence of salt water.

Materials that have many of these attractive properties for absorbing are aerogels. Aerogels are solid materials with open foam-type structures allowing for penetration of various size compounds into the solid. They are synthesized using sol-gel techniques followed by drying techniques which impart a very high surface area (up to 1000 m²/g and greater) and high porosity. Modification by incorporation of chemical functionality can yield materials with specific chemical properties, such as hydrophobicty. For example, both the methyl and the perfluoro functional groups exhibit excellent properties in this regard, and they have been incorporated into silica aerogels, providing a durable hydrophobic material usable for separation of organic materials from mixtures of organics and water. The present invention involves using a hydrophobic-silica aerogel as a powder or granular form to absorb oil from oil-salt-water mixtures which simulate oil-spill conditions, but also have a variety of different applications. More specifically, the addition of fluorine to the aerogel either during the sol-gel processing or by vapor treatment of a dried aerogel produces a very high hydrophobic property, and it has been found that using up to about 30% of the hydrophobic-type precursor (3,3,3-trifluoropropyl)-trimethoxysilane and drying under aerogel formation conditions (such as supercritical drying) transparent hydrophobic aerogels can be provided.

### SUMMARY OF THE INVENTION

It is an object of the present invention to provide for spill recovery using hydrophobic aerogels.

A further object of the invention is to provide a hydrophobic sol-gel or aerogel capable of absorbing oil from an oil-water mixture.

Another object of the invention is to provide an aerogel that absorbs and separates oil from oil-water mixtures.

Another object of the invention is to provide a device that absorbs and separates oil from oil-water mixtures.

Another object of the invention is to provide a device that absorbs and separates oil from oil-water mixtures which involves combining a hydrophobic absorbent material with a support which gives the absorbent a place to reside.

Another object of the invention is a method of oil spill recovery from an oil-salt-water mixture using hydrophobic fluorine containing sol-gels and aerogels.

Other objects and advantages of the present invention will become apparent from the following description. Basically, the invention involves a device which is a combination of a hydrophobic aerogel on a solid support material that absorb and separates oil from oil-water mixtures. The hydrophobic aerogel is a process utilizing a sol-gel technique, when an oil-water mixture is brought into contact with the device, the aerogel will preferentially absorb and retain the oil phase, rejecting the water phase, which may result in two separated streams, an oil only stream, and a water only stream. A hydrophobic aerogel synthesized through the combination of tetramethylorthosilicate and (3,3,3,trifluoropropyl)-trimethoxysilane has significant oil absorbing properties on oil-salt water mixtures. For example, the CF₃-functionalized aerogel was found to:

a. completely absorb oil at oil/aerogel ratios up to 3.5, producing a dry solid when separated from the water,

b. form an emulsion at oil/aerogel ratios of 4.6 to 14, which was easily separated from the water,

c. absorb only art of the oil at oil/aerogel ratios 16 and greater, with free-phase oil being observed,

d. be extractable and reusable for at least 2 times additionally,

e. absorb oil 40 to 140 times better than the non-functionalized silica aerogel,

f. have a higher oil absorbing capacity when in a non-powder form, and

g. perform equally well with two different crude oils.

The device of this invention can be used in any water environment that has been contaminated with oil, such as motor oil, crude oil, or oily waste. It can be used for clean-up of ground water that has been contaminated with oil by pumping the ground water out and contacting it with the device. Also, the device can be utilized to clean oil spills in the ocean or rivers, waste oil deposits in the harbors, and environmental oil spills by industries, to name only a few of its applications.

### DETAILED DESCRIPTION OF THE INVENTION

The present invention involves a device and method that absorbs and separates oil from oil-water mixtures and is particularly applicable for oil spill recovery. The device uses hydrobolic sol-gels and aerogels. The device is a combination of a hydrophobic aerogel on a solid support material. When the device is brought into contact with an oil-water mixture, the aerogel will preferentially absorb and retain the oil phase, rejecting the water phase.

The aerogel synthesis incorporates typical sol-gel techniques with the addition of a hydrophobic-type precursor (such as 3,3,3-trifluoropropyl)-trimethoxysilane) and drying under aerogel formation conditions (such as supercritical drying). An example of the synthesis of the hydrophobic aerogel and characterization of the aerogel has been described in UCRL-JC-144150, Reynolds et al, 2001, Hydrophobic Aerogels for Oil Spill Clean Up-Synthesis and Characterization J. Non-Crystal. Solids, 2001. The formulation used in Reynolds et al, 2001, was as follows: 10.4 g NH₄OH, 44 g Dl H₂O, and 90 g CH₃OH were mixed together and left stirring until cooled to room temperature. In a separate vessel, 75.0 g tetramethylorthosilicate were mixed with 37.5 g (3,3,3-trifluoropropyl)-trimethoxysilane and let stir at room temperature for 5 minutes. To this solution, 90 g CH₃OH were added. After the solution became homogeneously mixed, the NH₄OH solution was added and mixed. The solution gelled within 20 minutes. The gel produced was placed in a supercritical exchange reactor system to form the aerogel (CF₃-aerogel) by supercritical extraction with CH₃OH at 2000 psig, 295-300° C. for 4 hours, followed by depressurization at 50 psig/min.

The support material of the above-referenced device can be any solid support material. Examples of commercially available support materials are fiberglass, alumina, insulation, alumina tiles, dacron and cotton wool, and vitreous carbon foam. These support materials may be cut and formed to the appropriate size and weight for the application.

The intrinsic oil-absorbing properties of the hydrophobic aerogel were established by mixing the following: 40 g of 3 wt % NaCl in DI H₂O and varing amounts of crude oil were put in 200 mL wide mouth bottles. Approximately 0.36 g of aerogel were placed in each of these bottles. Each bottle was sealed with a screw-top cap lined with Teflon, and each was then shaken for 5 min and left to settle. The next day, each bottle was again shaken for 5 min. The bottles were then left to settle for 30 min or more, before separation. When settled, the oil-water mixtures were separated. The method depended upon visible assessment of the mixture. In cases where the aerogel absorbed all the oil, the aerogel was separated from the water by filtration through Watman No. 5 filter paper. The solid was rinsed several times with DI H₂O to remove any residual NaCl. The solid was then left to dry either in air or under vacuum. The dried aerogel was then soxhlet extracted with a ⁹²% CH₂Cl₂/8 vol % CH₃OH solvent mixture until the extraction solvent was colorless (approximately 24 h). The solid was then dried in vacuum and the extracted oil solution was dried under blowing N₂. Recoveries were determined by weighing the isolated residual materials. In cases where an emulsion was formed, the mixture was poured into a tube and centrifuged for 1 h at 5000 rpm. Free-phase oil (if any) was decanted off the top, and the emulsion was displaced to allow the water to be poured off. The emulsion was then broken by adding several mL of CH₂Cl₂. To this mixture, DI H₂O was added and the tube was shaken. The mixture was centrifuged for 1 h and the H₂O layer was decanted. This was repeated 2 times to remove any residual NaCl. The solvent was then filtered to recover the aerogel through Watman No. 5 filter paper. The solid was left to dry in the air and then extracted as described above. Solvent of the solution from the filtration was removed by blowing N₂.

Results of the intrinsic oil-absorbing properties are set forth herein after in Table 1.

TABLE 1
Weights (g) of oil and aerogel in experiments using CF₃-functionalized aerogel to absorb oil
from mixtures of crude oil and salt water (starting quantities are 0.36 g aerogel powder, 40 g
H₂O containing 3 wt % NaCl).

| | | Spent | Extracted | Extracted | Emulsion | Free-Phase | O/A |
|---|---|---|---|---|---|---|---|
| Exp. | Oil | Aerogel^{a} | Aerogel^{b} | Oil^{c} | Oil^{d} | Oil^{e} | Ratio |
| 1^{f} | 0.21 | 0.50 | 0.30 | 0.16 | — | — | 0.55 |
| 2^{f} | 0.22 | 0.52 | 0.34 | 0.29 | — | — | 0.60 |
| 3^{f} | 0.41 | 0.66 | 0.31 | 0.31 | — | — | 1.2 |
| 4^{f} | 0.41 | 0.67 | 0.34 | 0.18 | — | — | 1.2 |
| 5^{f} | 0.81 | 1.1 | 0.34 | 0.72 | — | — | 2.3 |
| 6^{f} | 0.82 | 1.0 | 0.34 | 0.69 | — | — | 2.3 |
| 9^{f} | 1.3 | 1.3 | 0.35 | 1.0 | — | — | 3.5 |
| 10^{f} | 1.6 | 0.40 | 0.28 | 0.12 | 1.3 | — | 4.6 |
| 11^{f} | 2.0 | 0.60 | 0.34 | 0.35 | 0.9 | 0.27 | 5.6 |
| 13^{f} | 3.1 | 0.85 | 0.34 | 0.52 | 1.6 | 0.31 | 8.5 |
| 15^{f} | 3.2 | 0.35 | 0.31 | 0.05 | 2.4 | na^{g} | 9.1 |
| 16^{f} | 5.0 | 0.68 | 0.33 | 0.32 | 4.3 | 0.07 | 14. |
| 17^{f} | 5.7 | 0.47 | 0.32 | 0.15 | 2.8 | 1.5 | 16. |
| 18^{f} | 6.4 | 0.67 | 0.33 | 0.28 | 2.4 | 3.4 | 18. |
| 19^{f} | 10. | 0.27 | 0.15 | 0.14 | 2.6 | 5.8 | 28 |
| 7^{f,h} | 0.80 | 1.0 | 0.34 | 0.66 | — | — | 2.4 |
| 8^{f,i} | 0.80 | 0.96 | 0.33 | 0.56 | — | — | 2.4 |
| 12^{f,j} | 2.0 | 2.1 | 0.34 | 1.7 | — | — | 5.7 |
| 14^{k} | 3.3 | 0.67 | 0.36 | 0.30 | 1.4 | 0.30 | 9.0 |

^{a}wt of aerogel after isolation from mixture, before soxhlet extraction
^{b}wt of aerogel after soxhlet extraction with CH₂Cl₂/CH₃OH solvent mixture
^{c}oil recovered from extraction in note b)
^{d}amount of oil recovered from breakdown of emulsion
^{e}amount of oil not absorbed by aerogel or aerogel-oil-water emulsion
^{f}Prudhoe Bay crude oil
^{g}oil lost in work-up
^{h}reuse of extracted aerogel from Experiment 5 (0.34 g aerogel)
ⁱreuse of extracted aerogel from Experiment 7 (0.34 g aerogel)
^{j}aerogel large chunks, not powder
^{k}Phillips crude oil substituted for Prudhoe Bay crude oil

The results indicate the aerogel has excellent oil absorbing properties in weight ratios of oil to aerogel of 14/1.

Table 2.

Weights (g) of oil and aerogel in experiments using CF₃-functionalized aerogel to absorb oil from mixtures of crude oil and salt water (starting quantities are 0.36 g aerogel power, 40 g. H₂O containing 3 wt % NaCl).

TABLE 2

| | | Spent | Extracted | Extracted | Emulsion | Free-Phase | O/A |
|---|---|---|---|---|---|---|---|
| % CF₃ | Oil | Aerogel^{a} | Aerogel^{b} | Oil^{c} | Oil^{d} | Oil^{e} | Ratio |
| 30^{f} | 1.3 | 1.2 | 0.35 | 0.88 | none | none | 3.5 |
| 10^{f} | 1.3 | 1.2 | 0.34 | 0.86 | none | none | 3.5 |
| 1.5^{g} | 1.3 | 1.3 | 0.35 | 0.92 | none | none | 3.5 |
| 0^{f,i} | 1.3 | 1.2 | 1.1 | 0.06 | none | 1.24 | 3.5 |

^{a}wt of aerogel after isolation from mixture, before soxhlet extraction,
^{b}wt of aerogel after soxhlet extraction with CH₂Cl₂/CH₃OH solvent mixture,
^{c}oil recovered from extraction in note b,
^{d}amount of oil recovered from breakdown of emulsion,
^{e}amount of oil not absorbed by aerogel or aerogel-oil-water emulsion,
^{f}Prudhoe Bay crude oil,
^{g}Phillips crude oil,.
ⁱCalculated from results from Reynolds et al., Energy Sources using data from this study.

The amount of CF₃(CH₂)₂Si(OCH₃)₃ starting material in the synthesis of the aerogel was decreased to determine how efficient the aerogel is for oil spill cleanup. Table 2 shows the results of the oil absorption experiments at an O/A of 3.5. Treating oil and salt-water mixtures with the aerogel at an oil to aerogel ratio of 3.5 showed all the formulations containing CF₃-in Table 2 cleanly separated the oil from the water, regardless of the percentage of CF₃—(CH₂)₂-group. This implies that the capacity of the CF₃-aerogels mixtures can be as high as 237 parts oil to 1 part aerogel.

The formation of the aerogel-support material device is by contacting the aerogel above with the support material. This can be done by dipping the support material in the powdered aerogel, by dipping it in a slurry of the aerogel in a solvent, or by any other coating method. An example of the coating method is: 0.9 inch diameter discs of fiberglass (house insulation) weighing 0.09 to 0.14 g were dipped into a solution of a 15 wt % CF₃-aerogel in acetone, two times and vacuum dried between dips. This place approximately 0.3 g of aerogel on the discs. These discs were used for application with no further treatment.

The aerogel coated support material was tested under a variety of conditions. The following are examples:

1) Untreated fiberglass. 25 g water (with 3 wt % dissolved NaCl) were shaken with 2.2 g motor oil. 0.1 g piece of fiberglass was placed on the surface of the oil-water sample and left for 24 hours. After 3 hours, the fiberglass piece sank to the bottom of the container. After 24 hours, the piece was removed and weighed at various times. The net weight gain of the fiberglass was the following—0 hr, 4 g; 10 h, 3.3 g; 24 h, 3.2g.

2) CF₃-aerogel coated fiberglass. 25 g of water (with 3 wt % dissolved NaCl) were shaken with 2.2 g motor oil. 0.1 g piece of fiberglass coated with 0.3 g CF₃-aerogel was placed on the surface of the oil-water sample and left for 24 hours. At no time did the coated fiberglass piece sink. After 24 hours, the piece was removed and weighed at various times. The net weight gain was the following—0 hr, 2.6 g; 10 h, 2.5 g; 24 h, 2.4 g.

The untreated fiberglass did not selectively absorb the oil, but absorbed water and oil as verified by the weight after absorption of 4 g (1.8 g over the total oil weight), and oil was still prominently visible on the surface of the water. The untreated fiberglass also sank to the bottom of the container, indicating a primarily water mixture was absorbed. The untreated fiberglass did not retain the oil. The large weight loss over a period of 10 h indicates this as well as oil and water were collected underneath the fiberglass piece.

The coated fiberglass selectively absorbed oil from the mixture. The initial weigh after absorption was close to the oil weight of 2.2 g, and there was no visible sign of oil on the surface of the water. The coated fiberglass also did not loose appreciated amounts of absorbed liquid over a period of 24 h based on the very little weight loss of the absorbed material.

3) In another set of experiments, a 12 g water (with 3 wt % dissolved NaCl) and a 12 g crude oil mixture were shaken with a 0.8 g fiberglass ball coated with 0.9 g CF₃-aerogel and left to sit. Immediately, all the oil was absorbed and no oil was visible on the surface of the water. After 24 h, no oil was observed. After 7 months a little oil sheen was seen on the surface of the water. A comparable sample was prepared but only using untreated fiberglass. When placed in the oil-water mixture, no absorption was evident. After 7 months, the sample appeared unchanged.

The results of the verification experiments are set forth in greater detail in UCRL-JC-140064, J. G. Reynolds et al, “Hydrophobic Aerogels for Oil-Spill Clean Up-Intrinsic Absorbing Properties”, Energy Sources, 23: 831-843 (2001).

It has thus been shown that the present invention provides a device and method of fabrication of the device that absorbs and separates oil from oil-water mixtures, and thus provides a method of oil spill recovery using hydrophobic sol-gels and aerogels. In addition to the applications of the invention identified above, it can be used for clean up of motor oil and transmission oil spills in water as well as mineral oil spills in water, and may be used for separating oily from aqueous waste for reclaiming and recycling oil. As set forth above, a hydrophobic aerogel synthesized through the combination of tetramethylorthosilicate and (3,3,3-trifluoropropyl)-trimethoxysilane was tested for oil absorbing properties on oil-salt water mixtures. The CF₃-functionalized aerogel was found to:

a. completely absorb oil/aerogel ratios up to 3.5, producing a dry solid when separated from the water.

b. form an emulsion at oil aerogel ratios of 4.6 to 14, which was easily separated from the water,

c. absorb only part of the oil at oil/aerogel ratios 16 and greater, with free-phase oil being observed,

d. be extractable and reusable for at least 2 times additionally,

e. absorb oil 40 to 140 times better than the non-functionalized silica aerogel,

f. have a higher oil absorbing capacity when in a non-powder form, and

g. perform equally well with two different crude oils

h. when formulated at low concentrations of CF₃-absorb 237 parts oil to 1 part aerogel.

While particular embodiments, materials, parameters, etc. have been described to exemplify and teach the principals of the invention, such are not intended to be limiting. Modifications and changes may become apparent to those skilled in the art, and it is intended that the invention be limited only by the scope of the appended claims.

What is claimed:

1. In a method for separating oil from an oil-water mixture, the improvement comprises:
providing an hydrophobic aerogel that absorbs and separates oil from the oil-water mixture.

2. The improvement of claim 1, additionally including providing a support for the hydrophobic aerogel.

3. The improvement of claim 1, additionally including forming the hydrophobic aerogel by incorporation of fluorine therein.

4. The improvement of claim 3, wherein the incorporation of the fluorine is carried out during aerogel synthesis.

5. The improvement of claim 3, wherein the incorporation of the fluorine is carried out by applying fluorine vapor to a dried aerogel.

6. The improvement of claim 3, wherein the incorporation of the fluorine is carried out by the addition of (3,3,3-trifluoropropyl)-triethoxysilane during sol-gel processing, and drying under aerogel formation conditions.

7. The improvement of claim 6, wherein the drying under aerogel formation conditions is carried out by supercritical drying.

8. The improvement of claim 1, wherein the hydrophobic aerogel is CF₃ aerogel.

9. The improvement of claim 1, additionally including forming the hydrophobic aerogel by synthesis incorporating typical sol-gel techniques with the addition of a hydrophobic-type precursor, and drying under aerogel formation conditions.

10. The improvement of claim 9, wherein the hydrophobic-type precursor is selected from material of the group consisting of (3,3,3-trifluoropropyl)-trimethoxysilane and methyl-trimethoxysilane

11. A device that absorbs and separates oil from oil-water mixtures, comprising:
a hydrophobic aerogel, and
a support for the aerogel.

12. The device of claim 11, wherein said hydrophobic aerogel contains fluorine.

13. The device of claim 11, wherein said hydrophobic aerogel was made hydrophobic by the addition of fluorine during the sol-gel process for forming the aerogel.

14. The device of claim 11, wherein said hydrophobic aerogel was made hydrophobic by treating a dried aerogel with fluorine vapor.

15. The device of claim 1, wherein the hydrophobic aerogel is composed of CF₃ aerogel.

16. A method of oil spill recovery using materials that absorb, comprising:
contacting the oil spill with a hydrophobic sol-gel material processed to be an aerogel,
whereby the hydrophobic aerogel absorbs and retains an oil phase, rejecting a water phase.

17. The method of claim 16, additionally including providing the hydrophobic aerogel with a support.

18. The method of claim 16, additionally including forming the hydrophobic aerogel by a sol-gel process which includes the addition of fluorine.

19. The method of claim 18, additionally including controlling an amount of fluorine added so as to produce a transparent hydrophobic aerogel.

20. The method of claim 16, wherein the hydrophobic aerogel comprises a CF₃-functionalized aerogel.

21. The improvement of claim 11, wherein the incorporation of the fluorine is carried out by the addition of (3,3,3-trifluoropropyl)-trimethoxysilane during the sol-gel processing and drying under aerogel formation conditions.
